(19) United States
(12) Patent Application Publication
(10) Pub. No.: US 2024/0246756 A1
(43) Pub. Date: Jul. 25, 2024

(54) Trash Bag Frame Device

(71) Applicant: Harry Toomey, Ladson, SC (US)

(72) Inventor: Harry Toomey, Ladson, SC (US)

(21) Appl. No.: 18/191,312

(22) Filed: Mar. 28, 2023

Related U.S. Application Data
(60) Provisional application No. 63/440,507, filed on Jan. 23, 2023.

(51) Int. Cl. B65F 1/14

(52) U.S. Cl. CPC B65F 1/1415; B65F 2240/138

(57) ABSTRACT

The present invention relates to a trash bag frame device. The device allows a single user to easily transfer fallen leaves into a trash bag. During use, the leg can be extended such that the device forms a generally square or rectangular structure, wherein a trash bag can be inserted through the top frame and secured to the top frame via the fastener. Then, a user can transfer leaves into the bag while it is supported by the frame.

### CROSS-REFERENCE TO RELATED APPLICATION

The present application claims priority to, and the benefit of, U.S. Provisional Application No. 63/440,507, which was filed on Jan. 23, 2023, and is incorporated herein by reference in its entirety.

### FIELD OF THE INVENTION

The present invention relates generally to the field of lawn care accessories. More specifically, the present invention relates to a trash bag frame device that allows a single user to easily transfer fallen leaves or other trash into a trash bag. During use, the leg can be extended such that the device forms a generally square or rectangular structure, wherein a trash bag can be inserted through the top frame and secured to the top frame via the fastener. Then, a user can transfer leaves into the bag while it is supported by the frame. Accordingly, the present disclosure makes specific reference thereto. Nonetheless, it is to be appreciated that aspects of the present invention are also equally applicable to other like applications, devices, and methods of manufacture.

### BACKGROUND

Many individuals bag fallen leaves in their yard using a trash bag. However, it is difficult to rake fallen leaves into a trash bag with only one individual. This is due to the fact that the user must try to simultaneously hold the trash bag open and attempt to rake the leaves into the bag. In addition, it may be difficult for a user to easily grab and move a bag full of leaves. This is also the case for any other trash that can be collected in a trash bag.

Therefore, there exists a long-felt need in the art for a device that can be used while collecting fallen leaves or other trash. There also exists a long-felt need in the art for a trash bag frame device that can be used to easily collect fallen leaves. More specifically, there exists a long-felt need in the art for a trash bag frame device that allows a singular user to collect fallen leaves. Further, there exists a long-felt need in the art for a trash bag frame device that allows a singular user to collect fallen leaves without having to hold open a trash bag. Finally, there exists a long-felt need in the art for a trash bag frame device that allows a singular user to collect fallen leaves and easily move the leaves once collected.

The subject matter disclosed and claimed herein, in one embodiment thereof, comprises a trash bag frame device. The device is primarily comprised of a top frame having at least one fastener, wherein the top frame is attached to a bottom frame via at least one leg. During use, the leg can be extended such that the device forms a generally square or rectangular structure. At least one trash bag can then be inserted through the top frame and secured to the top frame via the fastener. Then, a user can transfer leaves into the bag while it is supported by the frame. In addition, in one embodiment, the device allows a user to move the device easily via at least one wheel.

In this manner, the trash bag frame device of the present invention accomplishes all the foregoing objectives and provides a device that allows a singular user to easily collect fallen leaves or other trash. Further, the device does so without requiring that the user holds open a trash bag. In addition, the device allows a single user to easily move leaves once collected.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trash bag frame device primarily comprised of a top frame having at least one fastener, wherein the top frame is attached to a bottom frame via at least one leg. The device is comprised of a top frame and a bottom frame wherein both frames are preferably rectangular, square, triangular, circular, etc., in shape. The top frame and bottom frame are fixedly or removably attached to one another via at least one leg. The leg may be of a fixed length or may be telescopic and/or adjustable in length. In an adjustable embodiment, the leg can be collapsed when not in use, such that the overall footprint of the device can be reduced, and the device can be easily stored. In this adjustable embodiment, the leg is comprised of at least one locking mechanism that allows the leg to be locked at a fixed length.

The bottom surface (or in different embodiments, any surface) of at least one frame member of the top frame may be comprised of at least one fastener such as, but not limited to, a clip or a clamp fastener. However, the fastener may be any fastener type known in the art that can retain a trash bag on the frame. In this manner, the bag can be inserted into the frame and can remain secured to the frame as the device holds the bag open in a hands-free manner. In another embodiment, any surface of the bottom frame members may be comprised of the same fasteners. This holds the bottom of the trash bag taut to ensure the bag can be filled to maximum capacity during use.

The present invention may also be comprised of a method of use. First, the leg is extended and is secured using the locking mechanism in an embodiment of the device where the leg is not of a fixed length. Then, at least one trash bag is placed within the top frame, wherein the end of the trash bag is secured on the bottom surface of at least one frame member via at least one fastener. If the device has fasteners on the bottom frame, said fasteners can also be attached to the trash bag to ensure the bag is at full capacity. Next, the bag can be filled with fallen leaves (or any type of trash) by picking up the leaves (using any technique or tool known in the art) and/or trash and placing the leaves (or trash) into the body of the bag via the opening.

Accordingly, the trash bag frame device of the present invention is particularly advantageous as it provides a device that allows a single user to easily collect fallen leaves without requiring that the user holds open a trash bag. In addition, the device allows a single user to easily move leaves once collected. In this manner, the trash bag frame device overcomes the limitations of existing leaf collection methods known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a trash bag frame device of the present invention while extended in accordance with the disclosed architecture;

FIG. 2 illustrates a perspective view of one potential embodiment of a trash bag frame device of the present invention while collapsed in accordance with the disclosed architecture;

FIG. 3 illustrates a perspective view of one potential embodiment of a trash bag frame device of the present invention while extended and while holding a trash bag in accordance with the disclosed architecture; and

FIG. 4 illustrates a flowchart of a method of using one potential embodiment of a trash bag frame device of the present invention while extended in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that can be used while collecting fallen leaves. There also exists a long-felt need in the art for a trash bag frame device that can be used to easily collect fallen leaves. More specifically, there exists a long-felt need in the art for a trash bag frame device that allows a singular user to collect fallen leaves. Further, there exists a long-felt need in the art for a trash bag frame device that allows a singular user to collect fallen leaves without having to hold open a trash bag. Finally, there exists a long-felt need in the art for a trash bag frame device that allows a singular user to collect fallen leaves and easily move the leaves once collected.

The present invention, in one exemplary embodiment, is comprised of a trash bag frame device primarily comprised of a top frame having at least one fastener, wherein the top frame is attached to a bottom frame via at least one leg. The device is comprised of a top frame and a bottom frame. Both frames are preferably rectangular, square, triangular, circular, etc., in shape. The top frame and bottom frame are fixedly or removably attached to one another via at least one leg. The leg may be of a fixed length or may be telescopic and/or adjustable in length. In an adjustable embodiment, the leg can be collapsed when not in use, such that the overall footprint of the device can be reduced, and the device can be easily stored. In this adjustable embodiment, the leg is comprised of at least one locking mechanism that allows the leg to be locked at a fixed length.

The bottom surface (or in different embodiments, any surface) of at least one frame member of the top frame may be comprised of at least one fastener such as, but not limited to, a clip or a clamp fastener. However, the fastener may be any fastener type known in the art that can retain a trash bag on the frame. Accordingly, a trash bag can be inserted into the frame and can remain secured to the frame as the device holds the bag open in a hands-free manner. In another embodiment, any surface of the bottom frame members may be comprised of the same fasteners. This holds the bottom of the trash bag taut to ensure the bag can be filled to maximum capacity during use.

The present invention may also be comprised of a method of use. First, the leg is extended and is secured using the locking mechanism in an embodiment of the device where the leg is not of a fixed length. Then, at least one trash bag is placed within the top frame, wherein the end of the trash bag is secured on the bottom surface of at least one frame member via at least one fastener. If the device has fasteners on the bottom frame, said fasteners can also be attached to the trash bag to ensure the bag is at full capacity. Next, the bag can be filled with fallen leaves (or any type of trash) by picking up the leaves (using any technique or tool known in the art) and/or trash and placing the leaves (or trash) into the body of the bag via the opening.

Accordingly, the trash bag frame device of the present invention is particularly advantageous as it provides a device that allows a single user to easily collect fallen leaves without requiring that the user holds open a trash bag. In addition, the device allows a single user to easily move leaves once collected. In this manner, the trash bag frame device overcomes the limitations of existing leaf collection methods known in the art.

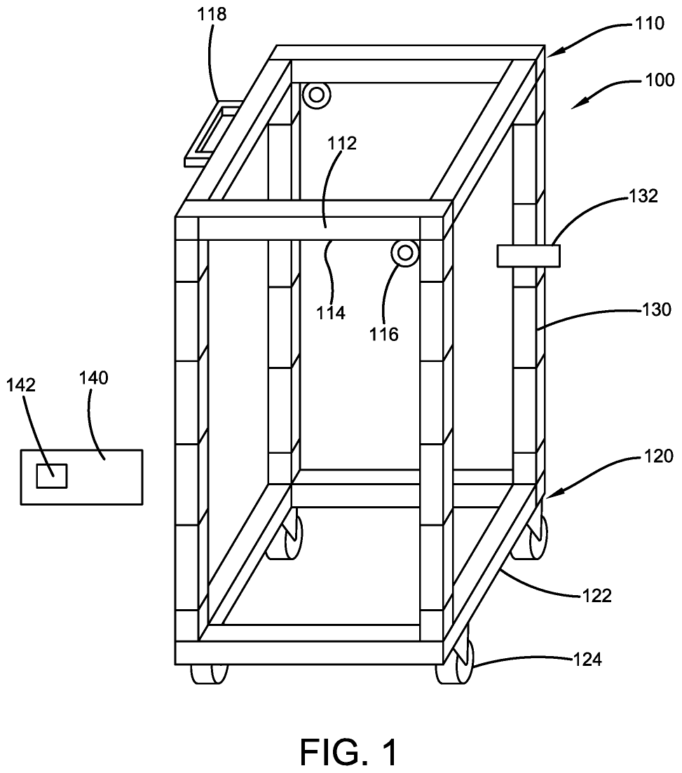

Referring initially to the drawings, FIG. 1 illustrates a perspective view of one potential embodiment of a trash bag frame device 100 of the present invention while extended in accordance with the disclosed architecture. The device 100 is primarily comprised of a top frame 110 having at least one fastener 116, wherein the top frame 110 is attached to a bottom frame 120 via at least one leg 130. The device 100 and all components may be made from a rigid plastic material such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. In another embodiment, the device 100 may be made from a corrosion-resistant metal material such as, but not limited to, stainless steel or aluminum.

The device 100 is comprised of a top frame 110 and a bottom frame 120. Both frames are preferably rectangular, square, triangular, circular, etc., in shape. The top frame 110 and bottom frame 120 are made from a plurality of frame members 112,122 that may be fixedly or removably attached to one another.

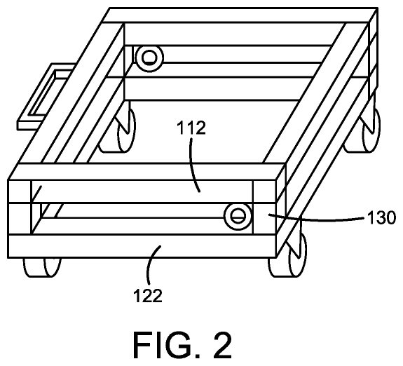

The top frame 110 and bottom frame 120 are fixedly or removably attached to one another via at least one leg 130. In one embodiment, the leg 130 is of a fixed length. In a different embodiment, the leg 130 is telescopic and/or adjustable in length. In this embodiment, the leg 130 can be collapsed when not in use, such that the overall footprint of the device 100 can be reduced and the device 100 can be easily stored, as seen in FIG. 2. In this adjustable embodiment, the leg 130 is comprised of at least one locking mechanism 132 that allows the leg 130 to be locked at a fixed length. In different embodiments, the locking mechanism 132 may be, but is not limited to a twisting locking ring, a pin, or any other locking mechanism found on a telescoping leg 130 known in the art.

In one embodiment, the frame members 122 of the bottom frame 120 may be comprised of at least one wheel 124. This allows the device 100 to be easily moved, especially when the device 100 is used with a trash bag 10 full of leaves. The wheel 124 may be any type of wheel known in the art such as, but not limited to, a rubber wheel, an inflatable wheel, a plastic wheel, a non-inflatable wheel, etc.

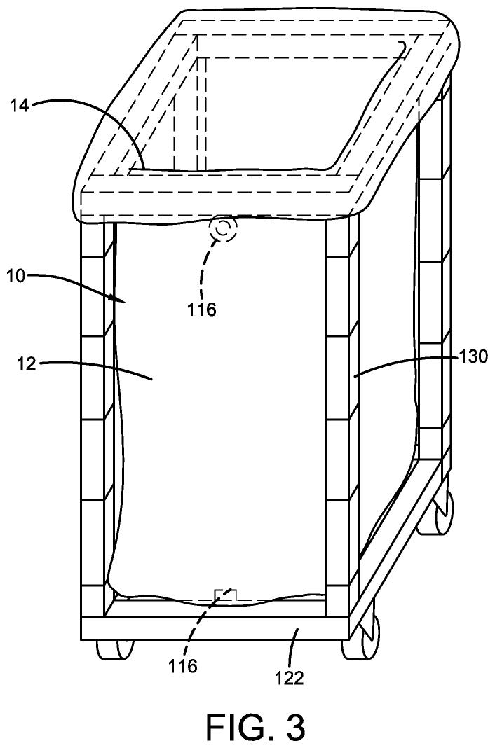

The bottom surface 14 (or in different embodiments, any surface) of at least one frame member 112 of the top frame 110 may be comprised of at least one fastener 116. The fastener 116 is comprised of a clip or a clamp fastener. However, the fastener 116 may be any fastener type known in the art that can retain a trash bag 10 on the frame 110. In this manner, the bag 10 can be inserted into the frame 110 and can remain secured to the frame 110 as the device 100 holds the bag 10 open in a hands-free manner, as seen in FIG. 3. In another embodiment, any surface of the bottom frame members 122 may be comprised of the same fasteners 116 to hold the bottom of the trash bag 10 taut to ensure the bag 10 can be filled to maximum capacity during use.

In one embodiment, the top frame 110 may be comprised of at least one handle 118. The handle 118 can be used to grab and move the device 100. This is particularly advantageous when a bag 10 is full and the device 100 and bag 10 must be moved.

In one embodiment, the device 100 may be comprised of at least one strap 140. The strap 140 allows the device 100 to be secured to another object, item, structure, vehicle, etc. The strap 140 is preferably a fabric, elastic, and/or rubber strap 140. The strap 140 is preferably comprised of at least one fastener 142 that allows the strap 142 to attach to itself or another surface. The fastener 142 is preferably a hook and loop fastener, but may be any fastener type known in the art.

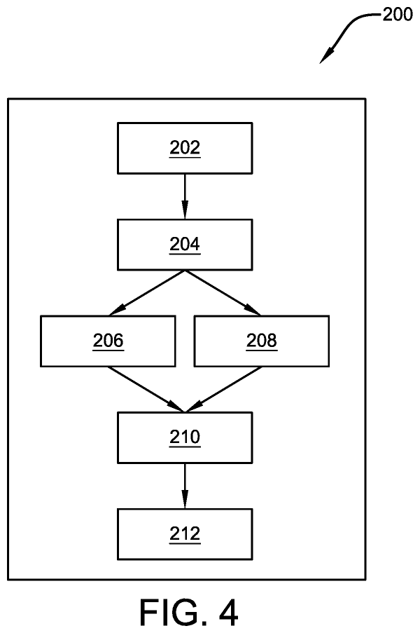

FIG. 4 illustrates a flowchart of a method 200 of using one potential embodiment of a trash bag frame device 100 of the present invention while extended in accordance with the disclosed architecture. The present invention may also be comprised of a method of use 200. First, the leg 130 is extended and is secured using the locking mechanism 132 in an embodiment of the device 100 where the leg 130 is not of a fixed length [Step 202]. Then, at least one trash bag 10 is placed within the top frame 110, wherein the end of the trash bag 10 is secured on the bottom surface 114 of at least one frame member 112 via at least one fastener 116 [Step 204]. If the device 100 has fasteners 142 on the bottom frame 120, said fasteners 142 can also be attached to the trash bag 10 to ensure the bag 10 is at full capacity [Step 206]. Next, the bag 10 can be filled with fallen leaves (or any type of trash) by picking up the leaves (using any technique or tool known in the art) and/or trash and placing the leaves (or trash) into the body 12 of the bag 10 via the opening 14 [Step 208]. Once full, the bag 10 can be rolled (or in an embodiment where the device 100 has no wheels 124, dragged) to a desired location where the bag 10 can be removed from the fasteners 116, tied, and discarded [Step 210]. In an embodiment where the leg 130 is adjustable, the locking mechanism 132 can be unlocked such that the leg 130 can collapse to allow the device 100 to collapse for storage [Step 212].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trash bag frame device” and “device” are interchangeable and refer to the trash bag frame device 100 of the present invention.

Notwithstanding the foregoing, the trash bag frame device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trash bag frame device 100 as shown in the FIGS. are for illustrative purposes only, and that many other sizes and shapes of the trash bag frame device 100 are well within the scope of the present disclosure. Although the dimensions of the trash bag frame device 100 are important design parameters for user convenience, the trash bag frame device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trash bag frame device comprising:
a top frame comprised of a first frame member;
a fastener;
a bottom frame comprised of a second frame member; and
a leg.

2. The trash bag frame device of claim 1, wherein the fastener is positioned on the first frame member.

3. The trash bag frame device of claim 2, wherein the fastener is positioned on a bottom surface of the frame member.

4. The trash bag frame device of claim 1, wherein the fastener is comprised of a clip.

5. The trash bag frame device of claim 1, wherein the fastener is comprised of a clamp.

6. The trash bag frame device of claim 1, wherein the leg is comprised of a telescopic leg.

7. The trash bag frame device of claim 1, wherein the telescopic leg is comprised of a locking mechanism.

8. The trash bag frame device of claim 7, wherein the locking mechanism is comprised of a twisting locking mechanism or a pin.

9. The trash bag frame device of claim 1, wherein the top frame is comprised of a handle.

10. The trash bag frame device of claim 1, wherein the top frame is comprised of a round shape.

11. The trash bag frame device of claim 1, wherein the bottom frame is comprised of a round shape.

12. A trash bag frame device comprising:
a top frame comprised of a first frame member and a first fastener positioned on the first frame member;
a bottom frame comprised of a second frame member and a second fastener positioned on the second frame member; and
a leg.

13. The trash bag frame device of claim 12 further comprised of a wheel.

14. The trash bag frame device of claim 13, wherein the wheel is comprised of a rubber wheel.

15. The trash bag frame device of claim 11, wherein the first fastener is comprised of a clip or a clamp.

16. The trash bag frame device of claim 11, wherein the second fastener is comprised of a clip or a clamp.

17. The trash bag frame device of claim 11, wherein the top frame is comprised of a rectangular shape.

18. The trash bag frame device of claim 11, wherein the bottom frame is comprised of a rectangular shape.

19. The trash bag frame device of claim 11, wherein the trash bag frame device is comprised of a corrosion-resistant metal material.

20. A method of using a trash bag frame device, the method comprising:
providing a trash bag frame device comprised of a top frame comprised of a fastener, a bottom frame and a leg;
placing a trash bag within the top frame; and
securing the trash bag to the top frame via the fastener.
